(19) United States
(12) Patent Application Publication
(10) Pub. No.: US 2010/0056045 A1
(43) Pub. Date: Mar. 4, 2010

(54) Ultra Low Frequency-Based Radio Transmission System

(75) Inventors: Michael Jorgensen, Jamesville, NY (US); Curt Andersson, Manlius, NY (US)

Correspondence Address: KING & SPALDING, LLP, 1100 LOUISIANA ST., STE. 4000, ATTN.: IP Docketing, HOUSTON, TX, 77002-5213, US

(73) Assignee: Cooper Technologies Company, Houston, TX (US)

(21) Appl. No.: 12/202,966

(22) Filed: Sep. 2, 2008

(51) Int. Cl. H04B 7/24

(52) U.S. Cl. 455/39

(57) ABSTRACT

An ultra low frequency transmission system can provide communications, for example, messages, to an individual or a group in areas of a building where conventional transmission reception is limited. A communication system for a structure includes a transmitter and an antenna network extending substantially throughout the structure. The antenna network includes a first portion and a second portion. At least one location in the structure can receive a transmission from the first portion and the second portion of the antenna network. The antenna network is configured to receive the transmission from the transmitter and to communicate the transmission throughout the antenna network to at least one receiver configured to receive the transmission from the transmitter via the antenna network. The antenna network transmits the transmission using an ultra low frequency to the at least one receiver.

### TECHNICAL FIELD

The present application relates generally to systems and methods for utilizing ultra low frequency-based radio transmissions in a building or structure.

### BACKGROUND

In many locations throughout a building, reception for cellular telephones, pagers, or radios is limited. If an individual or a group is trapped in the building, especially in an emergency event where traditional communication systems are disrupted, it can be very difficult to communicate with the trapped individual or group.

If an emergency exists in a large building or arena, such as a power outage, it is difficult to communicate with first responders and/or personnel. Additionally, steel reinforcements could interfere with communication transmissions.

Therefore, it is desirable to have a building or structure with a communications system that can more effectively operate in areas of the building or structure with limited reception.

### SUMMARY

An ultra low frequency transmission system can provide communications, for example, messages, to an individual or a group in areas of a building where convention transmission reception is limited.

In one aspect, a communication system for a structure includes a transmitter and an antenna network extending substantially throughout the structure. The antenna network includes a first portion and a second portion. At least one location in the structure can receive a transmission from the first portion and the second portion of the antenna network. The antenna network is configured to receive the transmission from the transmitter. At least one receiver receives the transmission from the transmitter via the antenna network. The antenna network transmits the transmission using an ultra low frequency to the at least one receiver.

In another aspect, a method for establishing a communication network within a structure includes the extending an antenna network throughout the structure. The antenna network is configured to receive a transmission from a transmitter. At least one receiver is positioned in the structure. The at least one receiver receives a transmission from at least two portions of the antenna network.

These and other aspects, objects, and features of the invention will become apparent to those having ordinary skill in the art upon consideration of the following detailed description of exemplary embodiments exemplifying the best mode for carrying out the invention as presently perceived.

### BRIEF DESCRIPTION OF THE DRAWINGS

FIGS. 1a and 1b illustrate a system for transmitting and receiving messages within a structure according to an exemplary embodiment.

FIG. 2 is a perspective view illustrating an antenna network for transmitting and receiving messages within a structure according to an exemplary embodiment.

FIG. 3 is a cross-sectional view of an antenna network for transmitting and receiving messages within a structure as illustrated in FIG. 3, according to an exemplary embodiment.

FIG. 4 illustrates an antenna configuration within a structure according to an exemplary embodiment.

### DETAILED DESCRIPTION OF EXEMPLARY EMBODIMENTS

The invention may be better understood by reading the following description of non-limitative, exemplary embodiments with reference to the attached drawings wherein like parts of each of the figures are identified by the same reference characters.

The exemplary embodiments described herein use ultra low frequency-based radio communications. Ultra low frequency is the frequency between about 300 hertz and about 3 kilohertz. The wavelength of the ultra low frequency transmission can allow the sound waves to penetrate objects, such as walls, floors, and ceilings of a building. Ultra low frequencies can have a small bandwidth, so the amount of data in a communication may be limited. As a result, an ultra low frequency communication may contain only text.

An ultra low frequency transmission can penetrate through a building better than transmissions at many other frequencies, such as those used by cellular telephones. The transmission is of characters in a textual format. Although the exemplary embodiment discusses a one-way textual communication, it is envisioned that the systems and methods could include two-way communications or other formats besides or in addition to text.

Although the exemplary embodiment discusses a building, the invention is not limited to a particular building and may include an arena, stadium, oil rig, or other structure where it may be useful to communicate to an individual or group within that structure.

The exemplary embodiment described herein refers to the use of the systems and methods in the event of an emergency. For example, in the event that a portion of a building is destroyed, trapped individuals or a group can receive a transmission regarding assistance. Similarly, first responders, maintenance personnel, or other individuals can receive transmissions to provide assistance. Alternatively, the systems and methods can also be used for other purposes, such as productivity or enhancing business operations.

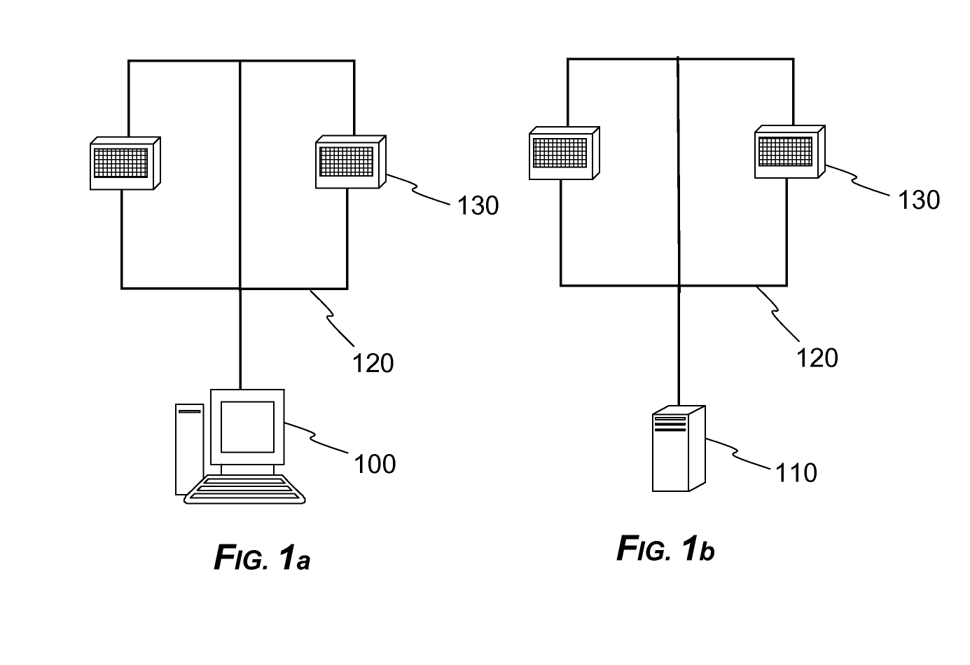

Referring to FIGS. 1a and 1b, a system for transmitting and receiving messages within a structure is illustrated. In FIG. 1a, a computer 100 having input access is shown. The computer 100 acts as a transmitter, but also allows a user to input messages to transmit through the system. In FIG. 1b, a transmitter 110 obtains messages from another source (not shown) for transmitting through the system.

The computer 100 or transmitter 110 can send a signal through an antenna network 120 to one or more receivers 130. The antenna network 120 has a conductor positioned throughout a building that acts as an antenna for transmitting messages. Receivers 130 can be configured to be portable devices or fixed devices within a building.

Messages can be sent to one, some, or all receivers depending on the type of message transmitted. For example, in an emergency, a message can be sent to all receivers saying that there is a fire and everyone should evacuate the building using the north stairwell. In another example, the system can send a non-emergency message to one person, such as a message to one receiver that requests that particular employee to report to the control room. In yet another example, a message can be sent to a plurality of receivers reporting that there is a security disturbance in a particular location.

Although receivers may be described herein as speakers or other fixed or portable audio units, receivers can also be cellular phones, pagers, or other communication devices capable of receiving particular communication frequency, such as ultra low frequency-based radio transmissions. Additionally, the receivers can be connected directly to the antenna network or may receive transmissions wirelessly from the antenna network. In an exemplary embodiment, the receivers can be transceivers configured to receive and transmit messages via the antenna network.

As a building is constructed, an antenna network can be integrated into the floors, ceilings, and/or walls of the building. The antenna network also can be wired in the exterior walls of the building and/or along the elevator shafts. Additional wiring in the antenna network may be needed based on the amount of steel reinforcement, concrete, or other electrical interference in the building.

The antenna network can be configured in any suitable pattern or layout in the building. In one embodiment, all or a portion of the antenna network can form a loop around or within the building, such as a loop on each floor. In another embodiment, all or a portion of the antenna network can form a loop having a second antenna wrapped around the loop.

The use of redundant loops can prevent a loss of communication should a portion of the antenna become damaged or destroyed. For example, a building can have an antenna extending throughout the elevator shafts and the exterior wall of the building, as well as an antenna loop on each floor. If a few floors are destroyed, the remaining floors will likely maintain communication through the redundant antennas covering that area.

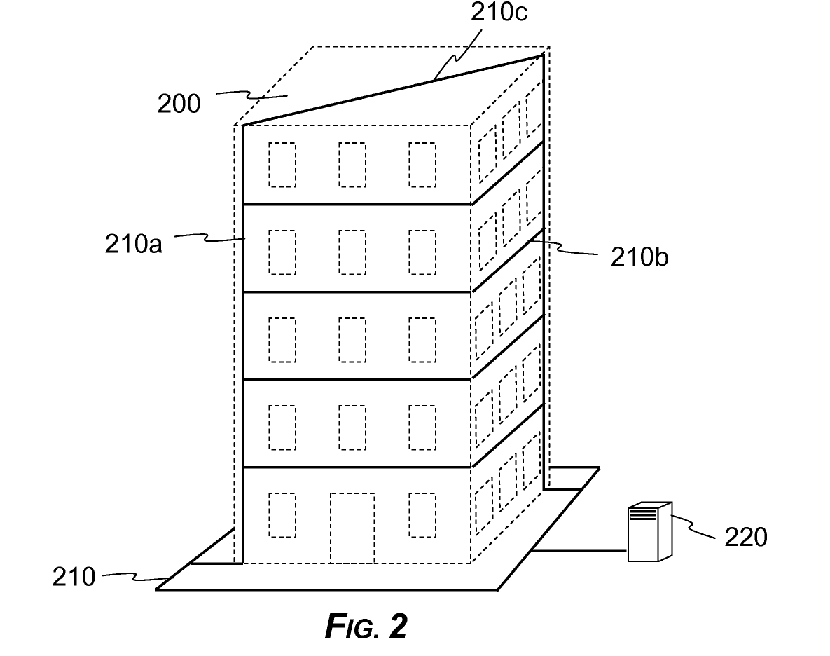

Referring to FIG. 2, an antenna network 210 for transmitting and receiving messages within a building 200 is illustrated. The antenna network 210 extends from a transmitter 220 (which can be located inside or outside of the building 200) is integrated within the walls, ceilings, and floors, and roof of the building 200 as the building 200 is built. Antenna network 210 can comprise a vertically extending portion 210a, multiple horizontally extending portions 210b at each floor, and/or a horizontally extending portion 210c on the roof.

Building 200 also may include a plurality of receivers (not shown) for receiving the transmissions from the antenna network 210. The receivers can be positioned on each floor, each hallway, and/or each stairwell, or any other desirable configuration, including personal receivers carried by persons in the building. The antenna network can be configured to allow communication from the transmitter 220 through the antenna network to at least one receiver located with an individual, in an area of the building, or throughout the entire building.

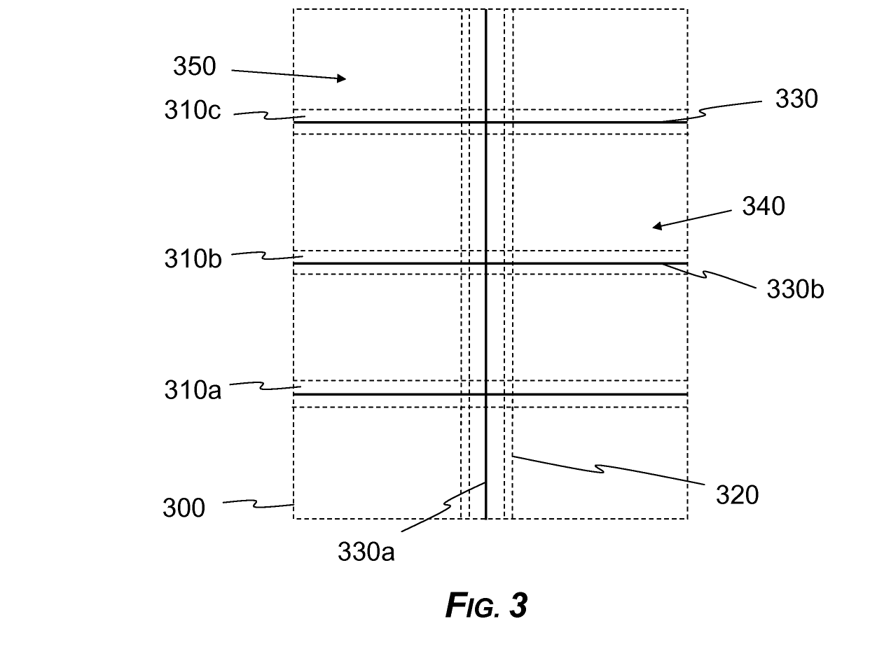

Referring to FIG. 3, a cross-sectional view of an antenna network 330 for transmitting and receiving messages within a building 300 is illustrated. Building 300 has a plurality of floors 310a, 310b, 310c and an elevator shaft 320. It is understood that building 300 is merely exemplary and that a building or structure can have a variety of configurations, including different size buildings, number of floors, stairwell and/or elevator design, or the like. During construction of building 300 or at a time after construction has been completed, building 300 can be wired with the antenna network 330. The antenna network 330 can include a vertical portion 330a extending through the elevator shaft 320 and/or horizontal portions 330b extending in the direction of each floor 310a, 310b, 310c.

Building 300 also may have multiple receivers (or transceivers) (not shown) for receiving the transmissions from the antenna network 330. The receivers can be positioned on each floor, each hallway, and/or each stairwell, or any other desirable configuration, including carried by a person within the building 300. The antenna network can be configured to allow communication from a transmitter through the antenna network 330 to at least one receiver located with an individual, in an area of the building, or throughout the entire building.

As a result of this configuration, if the first area 340 is subjected to conditions, such as a fire, that disables a portion of the antenna network 330, such as horizontal portion 330b, the first area may still receive a signal via vertical portion 330a or from a horizontal portion 330b on the floor above or below the first area 340. Additionally, a second area 350 would not be affected by a disabled portion of the antenna network 330 near first area 340 because of the redundancies and overlapping configuration of the antenna network 330.

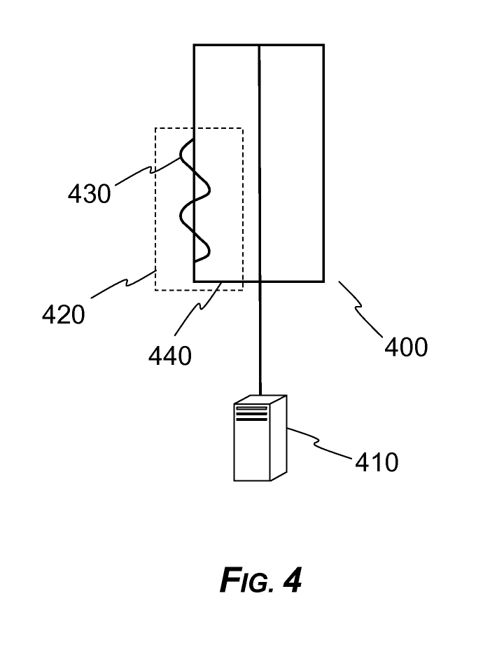

In an exemplary embodiment, at least a segment of an antenna network can be configured to wrap a first portion of antenna around a second portion of antenna. For example, referring to FIG. 4, an antenna network 400 extending from a transmitter 410 is illustrated. To reinforce the reception from the antenna network 400 in a segment 420 of the antenna network 400, a first antenna 430 can be wrapped substantially around a second antenna 440 and both antennas can be coupled to the transmitter 410. Segment 420 can include, but is not limited to, a floor of a building, a stairwell or elevator shaft, or other building or structural area. In an alternative exemplary embodiment, the multiple segments can be disposed in close relation to each other without being twisted or having one segment wrapped around the other segment. Additionally, more than two segments may be used to further improve reception and transmission. The redundant use of the first antenna 430 and second antenna 440 can improve reception in the segment 420 and can ensure reception from the antenna network 400 in the event either first antenna 430 or second antenna 440 becomes damaged.

Therefore, the invention is well adapted to attain the ends and advantages mentioned as well as those that are inherent therein. The particular embodiments disclosed above are illustrative only, as the invention may be modified and practiced in different but equivalent manners apparent to those having ordinary skill in the art and having the benefit of the teachings herein. While numerous changes may be made by those having ordinary skill in the art, such changes are encompassed within the spirit and scope of this invention as defined by the appended claims. Furthermore, no limitations are intended to the details of construction or design herein illustrated, other than as described in the claims below. It is therefore evident that the particular illustrative embodiments disclosed above may be altered or modified and all such variations are considered within the scope and spirit of the present invention as defined by the claims below. The terms in the claims have their plain, ordinary meaning unless otherwise explicitly and clearly defined by the patentee.

What is claimed is:

1. A communication system for a structure, comprising:
a transmitter that transmits a message using an ultra low frequency;
an antenna network extending throughout the structure, the antenna network comprising a first portion and a second portion,
wherein the antenna network is configured to receive the message transmitted by the transmitter; and
at least one receiver disposed in relation to the antenna network to receive the message from the transmitter via the antenna network.

2. The system according to claim 1, wherein the at least one receiver is wired to the antenna network.

3. The system according to claim 1, wherein the at least one receiver is wirelessly connected to the antenna network.

4. The system according to claim 1, wherein the structure is a building and the antenna network substantially extends along each floor of the building.

5. The system according to claim 4, wherein the antenna network further extends along at least one side of the building.

6. The system according to claim 4, wherein the antenna network further extends substantially across a roof of the structure.

7. The system according to claim 4, wherein the antenna network further extends substantially along an elevator shaft within the structure.

8. The system according to claim 1, wherein the structure is a building, arena, or oil rig.

9. The system according to claim 1, wherein the transmitter is located in the structure.

10. The system according to claim 1, wherein a segment of the antenna network comprises a first antenna wrapped substantially around a second antenna.

11. The system according to claim 1, wherein at least one location in the structure can receive a transmission from the first portion and the second portion of the antenna network.

12. A method for establishing a communication network within a structure, the method comprising the steps of:
extending an antenna network throughout the structure, wherein the antenna network is configured to receive a transmission from a transmitter; and
positioning at least one receiver in the structure, wherein the at least one receiver is configured to receive a transmission from at least two portions of the antenna network.

13. The method according to claim 12, wherein the antenna network is extended during construction of the structure.

14. The method according to claim 12, wherein the step of extending the antenna network comprises extending the antenna network along at least one side of the structure.

15. The method according to claim 12, wherein the step of extending the antenna network comprises extending the antenna network across a roof of the structure.

16. The method according to claim 12, wherein the step of extending the antenna network comprises extending the antenna network along each floor of the structure.

17. The method according to claim 12, wherein the step of extending the antenna network comprises extending the antenna network substantially along an elevator shaft of the structure.

18. The method according to claim 12, wherein the receiver communicates wirelessly with the antenna network.

19. The method according to claim 12, wherein the structure is a building, arena, or oil rig.

20. The method according to claim 12, wherein the communication network transmits transmissions using an ultra low frequency.

21. The method according to claim 12, further comprising the step of wrapping a first antenna substantially around a second antenna for at least a segment of the antenna network.
